(19) United States
(12) Patent Application Publication
(10) Pub. No.: US 2025/0305964 A1
(43) Pub. Date: Oct. 2, 2025

(54) HANDHELD DEVICE FOR DETECTING WELD DEFECTS AND A METHOD THEREOF

(71) Applicant: LTI Mindtree Ltd, Mumbai (IN)

(72) Inventors: Manjunatha Narasimha Murthy, Mumbai (IN); Ashok Kumar, Mumbai (IN)

(21) Appl. No.: 18/800,488

(22) Filed: Aug. 12, 2024

(30) Foreign Application Priority Data
Mar. 27, 2024 (IN) 202421024373

(51) Int. Cl. G01N 21/88

(52) U.S. Cl. CPC G01N 21/8851; G01N 2021/8854; G01N 2021/8887; G01N 2201/108; G01N 2223/629

(57) ABSTRACT

Provided is a handheld device and a method for detecting weld defects on a weld surface. The handheld device projects a thin beam laser light on the weld surface using a laser emitter. A processor receives the projected thin beam laser light from a laser receiving sensor, which indicates captured contours of the weld surface. The captured contours are processed to filter laser lines and extract contours. The extracted contours are utilized to classify a type of weld surface such as, surface joints, butt joints, corner joints, and tee joints. The processor, upon classifying, automatically adjusts angle and position of the laser light to be projected on the weld surface and detects deviation patterns by employing an ensemble of a laser line extraction process and a pixel width measurement process. The processor determines the detected deviation patterns as one or more defects on the weld surface that is being inspected.

### FIELD

Various embodiments of the present disclosure generally relates to weld defect detection. More particularly, the disclosure relates to a method and handheld device for laser-based weld defect detection, wherein the handheld device profiles a weld surface to be investigated and processes profile data in real-time to detect different types of defects on the weld surface.

### BACKGROUND

The current landscape of weld surface inspection relies predominantly on manual methods, heavily dependent on human intelligence and experience. The conventional approach necessitates the involvement of skilled professionals to visually examine and assess the quality of weld surfaces. The manual inspection process is characterized by several key aspects such as, for instance, subjectivity and variability, skill-development inspection, labor-intensive and time-consuming, limited real-time analysis, challenges in consistency, and dependency on visual inspection.

Additionally, current methodologies have a plurality of drawbacks such as for instance, fixing the detection device on a static platform, detection device with a separate controller that requires huge computing power, and requirement of external power source.

The methodology's reliance on a fixed static platform limits its flexibility. The approach requires the specimen to be moved at a constant speed, restricting the adaptability of the system to different welding scenarios and geometries. Complex or irregular surfaces may pose challenges for the fixed platform approach. Achieving uniform movement and data acquisition on intricate weld surfaces can be difficult, potentially leading to incomplete or inaccurate data collection.

The presence of separate controller and high computing requirements add complexity to the overall system architecture. This complexity may result in increased points of failure and maintenance. Devices with separate controllers and extensive computational demands often come with higher associated costs. The need for powerful computing components can contribute to elevated expenses in both device manufacturing and operation. Additionally, users may face limitations in terms of mobility and deployment flexibility, especially in scenarios where compact, portable solutions are desired.

The requirement for an external power supply restricts the mobility and accessibility of the detection device. This limitation is particularly relevant in field applications or scenarios where a continuous power source may not be readily accessible. The need for an external power supply increases the device's dependency on existing infrastructure. In remote or dynamic environments, where consistent power sources may be scarce, the device's operational capabilities may be compromised. The presence of external power connections may pose safety concerns, especially in industrial settings with multiple moving components. The risk of tripping hazards or damage to power cables could compromise both operational safety and the device's durability.

There is therefore a need for an advanced weld defects detection device and a method thereof.

### SUMMARY

The present disclosure discloses a handheld laser-based weld defect detection device and method. The handheld device projects a beam laser light on the weld surface that is being inspected using a laser emitter. A processor incorporated within the handheld device receives the projected beam of thin laser light from a laser receiving sensor, which indicates captured contours of the weld surface. The captured contours are processed by the processor to filter laser lines and extract contours of the weld surface. The extracted contours are utilized to classify a type of weld surface such as, not limited to, surface joints, butt joints, corner joints, and tee joints.

The processor, upon classifying the type of the weld surface, automatically adjusts angle and position of the thin beam laser light to be projected on the weld surface and detects deviation patterns by comparing the extracted surface contours with reference points using one or more pretrained statistical algorithms. In an embodiment, the processor employs an ensemble of a laser line extraction process and a pixel width measurement process for detecting the deviation patterns. Finally, the processor determines the detected deviation patterns as one or more weld defects on the surface that is being inspected, wherein the defects can be convex defects or concave defects. Convex defects can be such as, for instance, undercut defects, porosity defects, and cracks. Concave defects can be such as, for instance, spatter defects, and overlap defects.

One or more advantages of the prior art are overcome, and additional advantages are provided through the disclosure. Additional features are realized through the technique of the disclosure. Other embodiments and aspects of the disclosure are described in detail herein and are considered a part of the disclosure.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the disclosure.

FIG. 1 is a diagram illustrating an exemplary environment within which the method and device for detecting weld defects may function in accordance with various embodiments of the disclosure.

FIG. 2 is a diagram that illustrates a handheld device for detecting weld defects in accordance with an embodiment of the disclosure.

FIG. 3 is a diagram that illustrates a flow chart for a method for detecting weld defects on the weld surface in accordance with an embodiment of the disclosure.

FIG. 4 illustrates an exemplary diagram illustrating various stages in employing ensemble of the laser line extraction process and the pixel width measurement process for detecting concave down defects, in accordance with an embodiment of the disclosure.

FIG. 5 illustrates an exemplary diagram illustrating various stages in employing an ensemble of the laser line extraction process and the pixel width measurement process for detecting convex up defects, in accordance with an embodiment of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION

Before describing in detail embodiments that are in accordance with the present disclosure, it should be observed that the embodiments reside primarily in combinations of components related to a handheld device and method for detecting different types of weld defects on a surface in real-time. Accordingly, the method and device have been represented where appropriate by conventional symbols in drawing, showing only those specific details that are pertinent to understanding the embodiments of the present disclosure so as not to obscure the disclosure with details that will be readily apparent to those of ordinary skill in the art having the benefit of description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Various embodiments of the disclosure disclose a handheld laser-based weld defect detection device and method for detecting various types of defects on a weld surface in real-time. The handheld device projects a thin beam laser light on the weld surface that is being inspected, using a laser emitter. A processor within the handheld device receives the projected thin beam laser light from a laser receiving sensor, which indicates captured contours of the weld surface. The captured contours are processed by the processor to filter laser lines and extract contours of the weld surface. The extracted contours are utilized to classify a type of weld surface such as, not limited to, surface joints, butt joints, corner joints, and tee joints.

The processor, upon classifying the type of weld surface, automatically adjusts angle and position of the laser light to be projected on the weld surface and detects deviation patterns of the weld surface by comparing the extracted surface contours with reference points using one or more pretrained statistical models. Finally, the processor determines the detected deviation patterns as one or more defects on the weld surface that is being inspected.

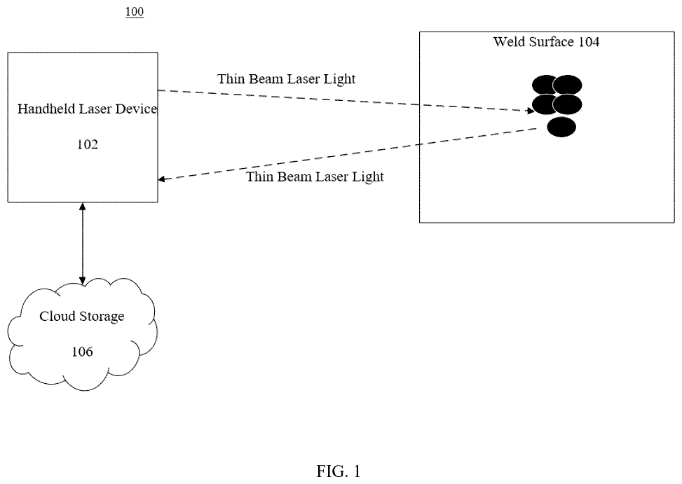

FIG. 1 is a diagram illustrating an exemplary environment 100 within which the method and device for detecting weld defects may function in accordance with various embodiments of the disclosure. Referring to FIG. 1, the environment 100 comprises a handheld device 102, a weld surface 104, and a cloud storage 106.

The handheld device 102 comprises a compact form factor housing with laser components and an integrated programmable processor 204. The laser component is configured to emit a thin beam laser light and profiles weld surfaces with precision. The processor 204, seamlessly integrated into the handheld device 102, processes the collected data in real-time to detect various types of weld defects and wirelessly communicate results to a remote user device for further analysis.

The processor 204, by utilizing one or more statistical algorithms, analyzes the weld surface topography to identify and classify the weld defects in real-time. The processor 204, by leveraging the one or more statistical algorithms, allows customization and adaptation to various welding applications, ensuring versatility across different welding processes and materials.

The weld defect detection process of the handheld device 102 is programmable, which allows defining specific geometric properties for the detection of weld defects. The handheld device 102 allows tailoring the defect detection criteria based on the geometric characteristics deemed critical for specific welding applications. The programmable nature of the handheld device 102 enables customization of parameters such as defect size, shape and orientation, allowing it to adapt to different welding scenarios, accommodating a wide range of defect types and variations.

By utilizing the statistical algorithms, the processor 204 of the handheld device 102 can analyze the laser-scanned data with precision, identifying deviations from the expected geometric norms. The statistical approach enhances the accuracy of defect detection and minimizes false positives, providing a reliable means to assess weld quality in real-time.

In an exemplary embodiment, statistical algorithms utilized by the processor 204 of the handheld device 102 are computational methodologies designed to analyze and interpret data patterns, providing valuable insights and predictions. In the context of present disclosure, these algorithms play a pivotal role in the weld defect detection process. These algorithms leverage mathematical principles to analyze distribution, variability, and relationships within the laser scanned data.

In accordance with the exemplary embodiment, common statistical techniques can be such as, but not limited to, regression analysis, clustering, and hypothesis testing. By employing at least one of the aforementioned algorithms, the handheld device 102 enhances its ability to discern meaningful patterns, facilitating precise defect detection while minimizing false positives. The analytical approach contributes to its adaptability across various welding applications, ensuring accurate and reliable real-time assessment of weld quality.

Referring to FIG. 1, the weld surface 104 can be an interface or joint created by fusion of materials through welding processes. The weld surface 104 can be a critical zone where two or more components are joined together, forming a cohesive and structurally integrated connection. The weld surface 104 can exhibit various characteristics influenced by factors such as welding techniques, material properties, and environmental conditions. Common features on the weld surface 104 can include bead profiles, penetration depth, and the presence of defects like cracks and discontinuities. The handheld device 102 is specifically designed to profile and analyze these weld surfaces in real time providing valuable data for defect detection and quality assessment during the welding process.

The cloud storage 106 of the present disclosure enhances functionality and accessibility of the handheld device 102, wherein the cloud storage 106 refers to utilization of remote servers accessible over the internet to store and manage laser-scanned data.

The cloud storage 106 of the present disclosure enables seamless and secure storage of the data generated during the weld surface profiling and defect detection process. This ensures that the data collected by the handheld device 102 is not only preserved but also easily retrievable for further analysis or documentation.

Moreover, the cloud storage 106 facilitates real-time collaboration and data sharing, allowing multiple remote users to access and review the collected data, promoting collaborative decision-making and facilitating a more streamlined workflow in welding operations. By leveraging cloud storage, the handheld device 102 enhances its scalability, as the volume of data increases.

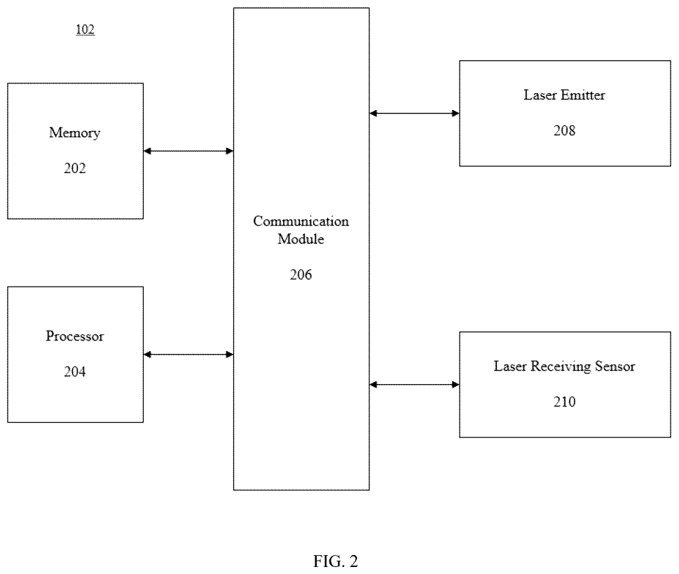

FIG. 2 is a diagram that illustrates the handheld device 102 for detecting weld defects in accordance with an embodiment of the disclosure. Referring to FIG. 2, the handheld device 102 comprises a memory 202, a processor 204, a communication module 206, a laser emitter 208, and a laser receiving sensor 210.

The memory 202 may comprise suitable logic and/or interfaces that may be configured to store instructions (for example, the computer-readable program code) that can implement various aspects of the present disclosure. In an embodiment, the memory 202 includes random access memory (RAM). In general, the memory 202 can include any suitable volatile or non-volatile computer-readable storage media.

The processor 204 may comprise suitable logic, interfaces, and/or code that may be configured to execute the instructions stored in the memory 202 to implement various functionalities of the handheld device 102 in accordance with various aspects of the present disclosure. The processor 204 may be further configured to communicate with multiple modules of the handheld device 102 via the communication module 206.

Computer readable program instructions are typically loaded onto the memory 202 to cause a series of operational steps to be performed by the processor 204 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions

are stored in various types of computer-readable storage media, such as the cache 206 and the other storage media discussed below. The program instructions, and associated data, are accessed by the processor 204 to control and direct the performance of the inventive methods.

The communication module 206 comprises suitable logic, interfaces, and/or code that may be configured to transmit data between modules, engines, databases, memories, and other components of the handheld device 102 comprising the laser emitter 208 and the laser receiving sensor 210 for use in performing functions discussed herein. The communication module 206 may include one or more communication types and utilize various communication methods for communication within the handheld device 102 comprising the laser emitter 208 and the laser receiving sensor 210.

The laser emitter 208 of the handheld device 102 projects a precise and focused laser beam onto the weld surface 104 under inspection. Designed for optimal performance, the laser emitter 208 utilizes advanced technology to emit a thin and concentrated beam of laser light. The focused beam ensures accuracy and resolution during profiling of the weld surface 104, allowing the handheld device 102 to capture intricate details and variations. The wavelength and intensity of the laser emitted are carefully calibrated to suit the specific requirements of the weld surface 104 under inspection. The thin beam laser provides a high level of precision, enabling the handheld device 102 to navigate and scan the weld surface 104 with meticulous detail.

The thin beam laser emitted by the laser emitter 208 ensures that the handheld device 102 can navigate intricate surface topographies, providing a comprehensive analysis of the welds on the weld surface 104.

The laser emitter 208 is configured not only for a single beam but also for a set of multiple thin beams to collectively cover the entire width of the weld surface 104.

The laser receiving sensor 210 of the handheld device 102 is configured to detect and capture contours from the weld surface 104 under inspection. As the thin beam laser light interacts with the weld surface 104, the laser capturing sensor 210 precisely captures the reflected data, creating a detailed map of contours that represent the topography of the weld.

In an embodiment, the laser receiving sensor 210 is also configured to receive a set of multiple thin beam laser lights emitted by the laser emitter 208, to cover full width of the weld surface 104. By having multiple thin beams, the laser receiving sensor 210 can capture data from different segments of the weld surface 204 simultaneously. This coverage allows for a more detailed and efficient profiling of the entire width of the weld surface 104, ensuring that no area is overlooked during the inspection process.

The configuration of multiple thin beams accommodates varying widths of weld surfaces. Whether the welding involves narrow or wide joints, the handheld device 102 can adapt by adjusting the distribution of the thin beams to ensure complete coverage.

The laser receiving sensor 210 operates in real-time, providing instantaneous results to the processor 204 for further analysis. This continuous capturing of contours is essential for the defect detection process, allowing the handheld device 102 to identify irregularities, discontinuities, or deviations from the expected weld surface characteristics.

The data collected by the laser receiving sensor 210 forms the basis for analysis of the weld surface 104. By converting the reflected laser light into digital format, the sensor enables generation of precise 3D models or representations of the weld contours. The detailed data set serves as a foundation for the programmable defect detection process.

The processor 204 receives crucial input from the laser receiving sensor 210, and provides detailed information about the contours detected on the weld surface 104. As the laser receiving sensor 210 precisely captures the reflected laser light interacting with the weld surface 104, it generates a stream of data indicating the contours and topography of the weld.

Upon receiving the input, the processor 204 processes the data in real-time, utilizing advanced algorithms to interpret the contours and identify any deviations or defects. The information derived from the laser receiving sensor 210 serves as basis for subsequent stages of the programmable defect detection process.

The processor 204, upon receiving input from the laser receiving sensor 210 that indicates contours from the weld surface 104 filters laser lines and extracts the precise contours of the weld surface 104, refining the data for more accurate defect detection and profiling.

The processor 204 employs advanced filtering techniques to distinguish and isolate the relevant laser lines representing the weld surface contours. The algorithm takes into account factors such as, but not limited to, intensity, continuity, and spatial relationships among the captured data points, ensuring that only the pertinent information is retained for further analysis. This filtering process enhances the signal-to-noise ratio, allowing the processor 204 to focus on the critical features of the weld surface 104.

Following the filtering step, the processor 204 proceeds to extract the contours of the weld surface 104 from the refined laser lines. The extraction process involves connecting and interpreting data points to reconstruct a detailed representation of the weld surface's 104 topography. The result is a highly accurate and digital model of the weld contours, providing a comprehensive basis for defect identification and analysis.

Subsequently, the processor 204 utilizes one or more classification algorithms to analyze the extracted contours and categorize them based on predefined criteria.

The classification algorithm employed by the processor 204 consider factors such as, contour shapes, dimensions, and overall topography to distinguish between different types of weld surfaces. These criteria are often customizable, allowing users to define specific parameters tailored to welding applications.

In an exemplary embodiment, the handheld device 102 classifies various types of weld surfaces, including, but not limited to, surface joints, lap joints, butt joints, corner joints, and tee joints.

Surface joints, characterized by their flat or planar configurations, are identified based on the specific contour patterns indicative of a continuous and even surface. Lap joints, which involve overlapping materials, exhibit contours that signify the overlapping nature of the weld, and the processor 204 adeptly recognized and classifies these features.

Butt joints, where two materials are aligned and welded at their edges, present unique contour characteristics that the processor 204 analyzes to classify this specific type of weld. Corner joints, formed by the intersection of two materials at right angles, showcase contours reflecting the distinct geometry of such joints.

Additionally, the tee joints formed by the connection of two materials at a perpendicular angle with a third material, exhibit contours that are distinctly classified by the processor 204.

In an embodiment, the handheld device 102 is configured to automatically adjust the angle and position of the laser light based on the classified surface type. This dynamic adjustment is enabled by the processor 204, which utilizes the information obtained from the classification of the weld surface 104 to optimize the laser beam's interaction with the material.

Upon classifying the type of weld surface 104, the processor 204 initiates a responsive mechanism to fine-tune angle and position of the laser emitter 208. For instance, when dealing with surface joints or lap joints, the processor 204 may optimize the angle to ensure consistent coverage and accurate profiling of the flat or overlapping surfaces. In the case of butt joints, corner joints, or tee joints, the processor 204 intelligently adjusts the laser angle and position to effectively capture the specific contours associated with these geometries.

After dynamically adjusting the angle and position of the laser emitter 208 according to the classified weld surface 104 type, the processor 204 enables the defect detection by detecting deviation patterns of the weld surface 104 by employing an ensemble of a laser line extraction process and a pixel width measurement process.

In accordance with an embodiment, during the laser light extraction process, the processor 204 receives an image of the weld surface 104 that is captured with specific contours associated with related geometries. The image, which represents a visual representation of the weld surface 104, is then processed to extract information about the surface characteristics based on extracted contours. The processing of the image occurs column by column, where the image is divided into one or more vertical segments of pixels. The dimensions of the image are identified by its height (h) and width (w), with each column representing a vertical strip of pixels extending from the top to the bottom of the image.

For each column of the vertical strip of pixels, the processor 204 performs a series of calculations to determine the weighted average pixel location as mentioned in the equation E1:

$$Gray ( u , v ) = \{ \begin{matrix}g ( u , v ) , & g ( u , v ) > th \\ 0 , & g ( u , v ) \leq th\end{matrix} \qquad E1$$

$$\overline{D} = \frac{{\sum }_{i = 0}^{m} {x}_{i} {g}_{i , v}}{{\sum }_{i = 0}^{m} {x}_{i}}$$

$$P = \frac{{\sum }_{i = 0}^{m} {x}_{i} {g}_{i , v}}{{\sum }_{i = 0}^{m} {g}_{i}}$$

Getting pixel density D and Weighted average position P where xi is pixel position from top and g (i, v) is pixel density at row i and v.

Determining the weighted average pixel location involves analyzing the intensity and distribution of pixel values within the column to identify the central of predominant area. The weighted average pixel location represents the point within the column that carries the visual significance of relevance in relation to the weld surface 104 and its geometries. The processor 204, by processing the image by column by column and calculating the weighted average pixel location, extracts spatial information about the weld surface 104.

The processor 204 then refines the obtained spatial information by removing outliers and noise by implementing moving average technique as per equation E2, which involves calculating average value of a specific number of adjacent data points, centered on each data point.

$$MA = \frac{1}{n} {\sum }_{i = 1}^{n} {D}_{i} \qquad E2$$

Running moving average, where D: Value and n: Window Size

Further, the processor 204, then computes the average value of the data points within the window size, which eliminates random fluctuations or irregularities in the data.

The processor 204 detects all peaks in the extracted contours from the weld surface 104 using one or more Z score based peak detection algorithms.

Z score based peak detection algorithms analyze statistical properties of the data to identify peaks, which represent deviations within the dataset. The Z score measures the number of standard deviations a data point is from the mean of the dataset. Peaks are identified as data points that exceed a certain threshold of standard deviations above mean, indicating their importance compared to the surrounding data.

Further, the processor 204 identifies required peaks, using equation E3 from all the peaks that are detected in Step 306, by analyzing characteristics of each detected peak to determine its relevance in defect detection process. In an instance, the processor 204 may consider one or more of amplitude threshold, peak width, spatial distribution, and peak context while identifying required peaks.

$$median \pm x * IQR \qquad E3$$

Where, IQR: Interquartile range; x: threshold

The processor 204 calculates the center of peak, from the identified required peaks, by finding mid-point of peak detection curve. The processor 204 finds the mid-point of the peak detection curve along the horizontal axis, representing the position of maximum intensity within the peak. The processor 204, marks the mid-point of the peak detection curve as p1 on the laser extracted curve.

After marking the midpoint of the peak (p1) on the laser extracted curve, the processor 204 calculates a point p2 by finding the next nearest point within a specified threshold distance along the curve. The threshold represents the maximum allowable distance p1 within which to search for the next nearest point.

The processor 204 may start along the laser extracted curve starting from p1 and searches for the nearest point that falls within the specified threshold distance, using the equation E4. Once a point within the threshold is identified, it is marked as p2.

$$Concave up - \frac{d}{d x} ( \frac{d y}{d x} ) > 0 or \frac{{d}^{2} y}{d {x}^{2}} > 0 \qquad E4$$

$$Concave down - \frac{d}{d x} ( \frac{d y}{d x} ) < 0 or \frac{{d}^{2} y}{d {x}^{2}} < 0$$

A curve representing the segment between points p1 and p2 on the laser extracted curve is generated. This curve, denoted as p1-p2 curve serves as the basis for determining the concavity of the region surrounding the detected peaks.

Finally, the processor 204 determines the deviation patterns as one or more weld defects by performing a double gradient or double differentiation operation on the p1-p2 curve, which evaluates the rate of change of the slope or curvature along the curve, providing insights into its concave or convex nature.

In accordance with an embodiment, during the width measurement process, the processor 204 calculates pixel width by finding the non-zero pixels by looking from top and from the bottom of each pixel column, using equation E5:

$$Gray ( u , v ) = \{ \begin{matrix}g ( u , v ) , & g ( u , v ) > th \\ 0 , & g ( u , v ) \leq th\end{matrix} \qquad E5$$

The processor 204 calculates the pixel width by scanning each column of pixels from the top of the image downwards. The processor 204 identifies the first non-zero pixel encountered within the column and records its position as the top boundary of the non-zero region. Similarly, the processor 204 scans each column from the bottom of the image upwards to identify the last non-zero pixel, marking its position as the bottom boundary of the non-zero region within the column.

The processor 204 then calculates the width of the pixel by subtracting the positions of the top and the bottom boundaries. The width measurement represents the extent of the non-zero pixel region within the column and serves as an indicator of spatial distribution and size of features or structures present in the weld surface 104.

Finally, the processor 204 forwards the variation in pixel width to an algorithm aimed at isolating segments where the width deviates from uniformity. The defect's width is then determined by assessing the segment's length and the disparity between its maximum and minimum values. Additionally, the algorithm identifies the concavity of the defect, facilitated by a double gradient technique applied to the pixel density for concavity classification.

Input: C → list /* change in laser line width */
Output: 0 → dict /* dictionary of {point: [width, height, concavity]}
Lists(concavity, width, height) /* temporary list to put concavity, width
and height of defect */ th → int /* threshold/sensitivity of detection */
while p in C:
if C[p] == 0:

| | |
|---|---|
| if | $\begin{matrix}\frac{cummprod ( abs ( buffer ) )}{cummsum ( abs ( buffer ) )} > th : \\ concavity ← 1 if C [ p + 1 ] > 0 , - 1 elif C [ p + 1 ] < 0 , \\ else 0 \\ width ← len ( buffer ) \\ height ← arg max ( abs ( buffer ) ) \\ buffer ← empty\end{matrix}$ |

```
      else:
      continue
  else:
    buffer.append(p)
```

In some non-limiting embodiments, the weld defects that are classified into meaningful categories may belong to convex defects and/or concave defects.

Convex defects refer to irregularities in the weld surface whether there is an outward bulging or protrusion. These defects typically manifest as raised areas of convex shapes on the weld joint. Convex defects may result from factors such as excessive weld material deposition, improper welding parameters, or inadequate control of the welding process. Convex defects, for example can be at least one of, undercut defects, porosity defects, and cracks.

Concave defects, on other hand, involve inward depression or indentations in the weld surface. These defects create a concave shape or recessed areas within the welded joint. Common causes of concave defects include insufficient weld materials, inadequate penetration, or uneven distribution of heat during the welding process. Concave defects, for example, can be at least one of spatter defects and overlap defects.

This classification into convex and concave defects provides a critical distinction that aids in understanding the nature and characteristics of identified anomalies. This categorization is valuable for both quality control and corrective measures, as it allows operators and inspectors to pinpoint the specific type of defect and tailor responses accordingly.

This determination process is guided by the predefined criteria of the processor 204, allowing customization based on the specific requirements of different welding applications. By delivering precise information about the nature and location of defects on the weld surface 104, the handheld device 102 empowers users to make informed decisions regarding the integrity of the welded joint. Additionally, the real-time nature of this determination process facilitates immediate corrective actions, contributing to enhanced efficiency, reduced rework, and improved overall weld quality.

In various embodiments of the disclosure, the handheld device 102 is also configured to detect defects on the weld surface 104 with multiple-beads (multiple-beads mentioned herein can also be termed as multiple welds) for heavy engineering welding applications.

The handheld device 102 is equipped to cover and analyze weld surfaces that involve the presence of multiple beads. This inclusivity ensures defect detection across the entire welded joint, regardless of the complexity introduced by multiple beads.

The handheld device 102 features an adaptive scanning mechanism that accommodates variations in bead patterns. This mechanism allows the handheld device 102 to navigate through the different beads, ensuring a thorough examination of the entire weld surface 104 with multiple beads.

To detect defects on surface with multiple beads, the device employs dynamic profiling capabilities, which adapts to changing topography created by each bead among multiple beads, capturing detailed information about variations, discontinuities, or irregularities specific to each bead.

In an embodiment, a laser emitted of the handheld device 102 is optimized to project a thin beam of laser light that effectively interacts with the varied topography of multiple beads on the weld surface 104. By focusing on defect detection across multiple beads, the device contributes to enhanced quality assurance in welding applications. It ensures that defects, whether located within or between beads, are promptly identified and addressed, preventing potential issues.

In accordance with the embodiment, the handheld device 102 detects spatter geometry of the weld surface 104 with multiple welds, wherein the spatter geometry can exist either on a flat weld surface or a curved weld surface.

Spatter geometry on the weld surface 104 refers to the distinctive patterns and formations of metal spatter generated during the welding process. Metal spatter consists of tiny droplets of molten metal that are expelled from the welding arc and can land on the welding surface 104. The spatter geometry encompasses the size, distribution, and arrangement of these spatter droplets, providing valuable insights into the welding conditions and parameters.

In one embodiment, the defect detection process for weld surfaces featuring multiple beads includes assessment of the entire weld surface area. This assessment is conducted to determine regions where changes occur and deviate from nearby cloud points. This evaluation is tied to the detected spatter geometry, which characterizes the patterns and formations of metal spatter on the weld surface.

During defect detection process, the handheld device 102 systematically analyzes the weld surface 104 area, identifying discrepancies where changes in spatter geometry do not match the characteristics of nearby cloud points. This embodiment leverages the correlation between spatter geometry and cloud point data to identify and highlight areas of interest, facilitating accurate and efficient detection of welding defects within the context of multiple beads on the weld surface 104.

In some non-limiting embodiments, detecting of the concavity and/or convexity is also done by finding differential (dy/dx) of the weld surface 104 portion under investigation. If the differential is identified to be positive, then the defect is convex or concave up. If the differential is identified to be negative, then it is concave down. Once the defects are classified into these two broader category, the next step is to classify the defects individually. Convex defects are individually classified into porosity, crack pattern, undercut, and spatter pattern.

Porosity always forms on the surface of the weld. It is generally circular in shape. Once the concavity up of curve is detected from the extracted laser line, it is further processed to find the location of the concavity. Alternatively, if it lies on the surface of the weld, then it can be either a crack pattern, or undercut. Multiple frames are considered together to differentiate between porosity, crack pattern, and undercut.

The spatter pattern captured is similar to undercut but it is concave down instead of concave up.

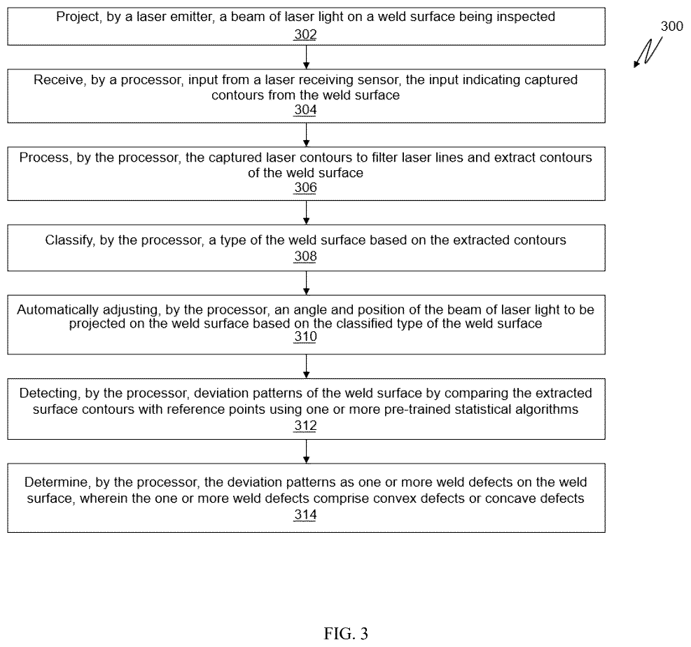

FIG. 3 is a diagram illustrating a flow chart 300 of a method for detecting weld defects on the weld surface 104 in accordance with an embodiment of the disclosure.

At step 302, the handheld device 102 activates the laser emitter 208 to project a thin beam of laser light onto the weld surface 104 that is under inspection. The laser emitter 208 is designed with precision to emit a concentrated and focused beam, ensuring accuracy and detail in profiling the weld surface 104. The thin beam serves as the probing tool, enabling the handheld device 102 to capture contours and variations on the weld surface 104.

At step 304, the processor 204 seamlessly interfaces with the laser receiving sensor 210, acquiring essential data that indicates the contours captured from the weld surface 104 during the profiling process. The laser receiving sensor 210, having captured the reflected laser light from the weld surface 104, transmits the data to the processor 204. The transmitted data represents a digital and detailed representation of the contours, topography, and features of the weld surface as illuminated by the thin beam laser light.

The laser receiving sensor's 210 precision ensures that subtle variations, surface irregularities, and distinct features are accurately captured and conveyed to the processor 204.

Further, at step 306, the processor 204 utilizes the contours received from the laser receiving sensor 210 as the initial data set for processing. By employing one or more algorithms, the processor 204 filters out extraneous data and laser lines, focusing on the contours that represent the actual features of the weld surface 104.

The processor 204 may employ interpolation techniques to connect and interpolate data points, reconstructing a more accurate and detailed representation of the weld surface 104. This processing stage enhances the signal-to-noise ratio, ensuring that the extracted contours effectively represent the weld surface's 104 true features.

Further, at step 308, the processor 204 applies advanced algorithms to classify the weld surface 104 based on the extracted contours. The classification process encompasses a range of weld surface types, providing a precise understanding of the joint being inspected. The types of weld surfaces considered include, but are not limited to, surface joints, lap joints, butt joints, corner joints, and tee joints.

The processor 204 analyzes the extracted contours, considering features such as shape, dimensions, and overall topography specific to each type of weld surface.

The classification criteria are customizable, allowing users to define parameters that are relevant to the distinct characteristics of surface joints, lap joints, butt joints, corner joints and tee joints.

Based on the analysis, the processor 204 identifies and categorizes the weld surface 104 into one or more types, providing valuable information about the joint configuration.

The algorithms employed are adaptive, ensuring that the handheld device 102 can accurately classify weld surfaces across varying conditions, materials, and welding techniques.

The classification occurs in real-time, allowing the device to dynamically adjust its parameters for subsequent stage of defect detection, tailoring its approach based on the identified weld surface type.

Furthermore, at step 310, the processor 204 dynamically adapts the angle and position of the laser light projected onto the weld surface 104, leveraging the knowledge obtained from the classified surface type. The adjustment ensures that the thin beam laser light is optimally positioned for accurate and detailed profiling based on the specific characteristics of the identified weld surface.

Utilizing the classified surface type information, the processor 204 initiates real-time adjustment to the angle and position of the laser emitter 208. The adjustments are precisely tailored to optimize the interaction of the thin beam laser light with the identified weld surface type. For instance, adjusting the surface joints may differ from adjustment made for lap joints, butt joints, corner joints, or tee joints.

By adapting the laser light angle and position, the processor 204 ensures enhanced precision in capturing contours and features specific to the classified surface type, minimizing the risk of overlooking critical details.

Furthermore, at step 312, the processor 204 engages in analysis to detect deviation patterns on the weld surface 104. This process involves comparing the extracted contours with reference points, utilizing one or more pre-trained statistical algorithms to identify anomalies and variations.

The processor 204 establishes a set of reference points representing the expected features of a detect-free weld surface. These points serve as a baseline for comparison. Pre-trained statistical algorithms such as, regression analysis, clustering or other pattern recognition methodologies are employed to compare the captured contours with the established reference points.

The statistical algorithms analyze the magnitude shape, and spatial distribution of deviations between the captured contours and the reference points, identifying pattern indicative of potential defects. Anomalies or irregularities that deviate from the expected contour patterns are recognized as potential deviations on the weld surface.

The statistical algorithms may employ adaptive thresholds, allowing the handheld device 102 to distinguish between acceptable variation and indications of actual defects based on the specific characteristics of the welding application.

Finally, at step 314, the processor 204 makes informed decisions based on the identified deviation patterns, ultimately determining whether one or more weld defects are present on the weld surface 104. This step synthesizes the analysis performed in earlier stages, culminating in a precise evaluation of the weld quality.

Leveraging the patterns of deviation identified in step 412, the processor 204 applies predefined criteria to determine the observed anomalies qualify as one or more weld defects. The processor 204 performs a comparative analysis between the captured contours and the reference points utilizing the insights gained from the statistical algorithms to differentiate between acceptable variations and actual defects.

The processor 204 categorizes the identified deviation patterns into specific types of weld defects. These may include, but are not limited to, cracks, porosity, irregular bead profiles, or other imperfections that deviate from expected contour patterns.

The processor 204 may generate reports or log data related to the identified defects, providing a comprehensive record for quality control purposes and future analysis. This step establishes a feedback loop using a feedback system, allowing the processor 204 to constantly learn and adapt its defect identification criteria based on evolving welding conditions and user-defined parameters.

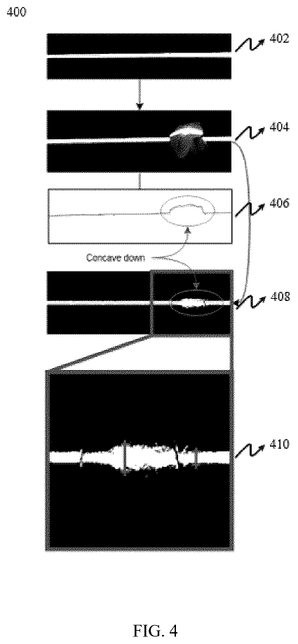

FIG. 4 illustrates an exemplary diagram 400 illustrating various stages in employing ensemble of the laser line extraction process and the pixel width measurement process for detecting concave down defects, in accordance with an embodiment of the disclosure.

At step 402, a focused thin beam laser light is projected onto the weld surface 104 using a laser emitter 208. At step 404, the projected thin beam laser light is directed towards the defects located on the weld surface 104 for inspection. At step 406 the laser line extraction process is employed, where it isolates and extracts the laser line projected onto the surface and at step 408, pixel width measurement process is employed, for analyzing variations in pixel width to identify potential defects or irregularities on the weld surface. Finally, at step 410, the handheld device 102 measures width change measurement and performs concave down defect classification.

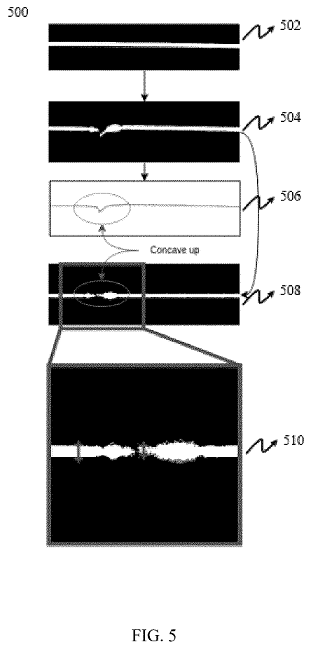

FIG. 5 illustrates an exemplary diagram 500 illustrating various stages in employing an ensemble of the laser line extraction process and the pixel width measurement process for detecting convex up defects, in accordance with an embodiment of the disclosure.

At step 502, a focused thin beam laser light is projected onto the weld surface 104 using a laser emitter 208. At step 504, the projected thin beam laser light is directed towards the defects located on the weld surface 104 for inspection. At step 506 the laser line extraction process is employed, where it isolates and extracts the laser line projected onto the surface and at step 508, pixel width measurement process is employed, for analyzing variations in pixel width to identify potential defects or irregularities on the weld surface. Finally, at step 510, the handheld device 102 measures width change measurement and performs concave up defect classification.

The present disclosure introduces a thin beam laser-light based detection of weld defects which provides more accurate and finer detection of defects, rather than by using natural light. Furthermore, the handheld device 102 detects weld defects based on geometric profile of weld surfaces, which allow users to detect defects by using statistical algorithms which are more accurate and precise.

Advantageously, by nullifying the use of external light source, the handheld device 102 can be used in low lighting or low illumination conditions, which will have better efficiency in detecting surface weld defects.

Advantageously, the handheld device 102 exhibits exceptional sensitivity, allowing it to detect and measure defects as small as 1 mm on the weld surface. This level of precision is crucial in industries where even minor imperfections can impact the structural integrity and performance of welding joints.

The handheld laser device's 102 ability to measure defects at such a small scale enables early detection of micro-defects that might escalate into more significant issues over time. This proactive approach contributes to preventive maintenance and avoids potential structural failure.

Furthermore, advantageously, the handheld device 102 detects weld defects in real-time at approximately 10 fps, which allows for continuous monitoring and quick decision-making during the welding process contributing to timely corrective actions.

The handheld laser device's 102 capacity to detect defects at a rate of 60 cm/min ensures high throughout in welding applications. This speed is particularly beneficial in industrial settings where efficiency and productivity are crucial considerations.

Additionally, the handheld device 102 has many advantages over traditional visual inspection techniques, which can contribute to high accuracy that can detect minute defects, non-contact inspection which avoids damage to weld surfaces, versatility which can be utilized for various materials and surfaces, and cost reduction.

Furthermore, the wireless connection enables remote monitoring and control of the handheld device 102. Users can access real-time data and results from a distance facilitating efficient oversight of welding processes without direct physical presence. Detected results can be transmitted instantaneously through the wireless connection. This rapid data transmission ensures that stakeholders receive timely information about the weld quality, enabling swift decision-making and intervention if necessary.

Those skilled in the art will realize that the above-recognized advantages and other advantages described herein are merely exemplary and are not meant to be a complete rendering of all of the advantages of the various embodiments of the present disclosure.

In the foregoing complete specification, specific embodiments of the present disclosure have been described. However, one of ordinary skill in the art appreciates that various modifications and changes can be made without departing from the scope of the present disclosure. Accordingly, the specification and figures are to be regarded in an illustrative rather than a restrictive sense. All such modifications are intended to be included within the scope of the present disclosure.

What is claimed is:

1. A method for detecting weld defects, comprising:
projecting, by a laser emitter, a beam of laser light on a weld surface being inspected;
receiving, by a processor, input from a laser receiving sensor, the input indicating captured contours from the weld surface;
processing, by the processor, the captured laser contours to filter laser lines and extract contours of the weld surface;
classifying, by the processor, a type of the weld surface based on the extracted contours;
automatically adjusting, by the processor, an angle and position of the beam of laser light to be projected on the weld surface based on the classified type of the weld surface;
detecting, by the processor, deviation patterns of the weld surface by comparing the extracted surface contours with reference points using one or more pretrained statistical algorithms; and
determining, by the processor, the deviation patterns as one or more weld defects on the weld surface, wherein the one or more weld defects comprise convex defects or concave defects.

2. The method as claimed in claim 1, wherein the beam of laser light comprises one of a single thin beam laser light and multiple thin beam laser lights.

3. The method as claimed in claim 1, wherein the extracted weld surface profile comprises at least one of surface patterns, surface material, and surface dimensions.

4. The method as claimed in claim 1, wherein the convex defects comprise at least one of undercut defects, porosity defects, and cracks.

5. The method as claimed in claim 1, wherein the concave defects comprise at least one or spatter defects and overlap defects.

6. The method as claimed in claim 1, wherein the weld surface being inspected comprises at least one of surface joints, lap joints, butt joints, corner joints and tee joint.

7. The method as claimed in claim 1, wherein the detection of deviation patterns on the weld surface is performed by employing an ensemble of a laser line extraction process and a pixel width measurement process.

8. A handheld device for detecting defects in on a weld surface, comprising:
a memory configured to store one or more executable components; and
a processor operatively coupled to the memory;
a laser emitter configured to emit as beam of laser light on to the weld surface being inspected;
a laser receiving sensor configured to capture the reflected laser light contours from the weld surface,
wherein, the processor is configured to execute instructions to:
receive and process the captured laser contours to filter laser lines and extract contours of the weld surface;
classify a type of the weld surface based on the extracted contours;
automatically adjust an angle and position of the laser emitter based on the classified type of weld surface;
detect deviation patterns of the weld surface by comparing the extracted contours with reference points using one or more pretrained statistical models; and
determine the weld defects based on detected deviation patterns.

9. The handheld device as claimed in claim 8, wherein the laser receiving sensor comprises a complementary metal oxide semiconductor (CMOS) sensor.

10. The handheld device as claimed in claim 8, wherein the handheld device is configured to analyze weld surfaces comprising single weld bead or multiple weld beads.

11. The handheld device as claimed in claim 8, wherein the handheld device employs a laser line extraction process and a pixel width measurement process to detect deviation patterns on the weld surface.
